(19) United States
(12) Patent Application Publication
(10) Pub. No.: US 2007/0298649 A1
(43) Pub. Date: Dec. 27, 2007

(54) IMPROVED ETHERNET CONNECTOR

(76) Inventor: Jeremy Amidon, Marcellus, NY (US)

Correspondence Address: SCHMEISER, OLSEN & WATTS, 22 CENTURY HILL DRIVE, SUITE 302, LATHAM, NY, 12110, US

(21) Appl. No.: 11/425,918

(22) Filed: Jun. 22, 2006

(51) Int. Cl. H01R 3/00

(52) U.S. Cl. 439/488

(57) ABSTRACT

A visual check connector comprising a body having a top surface, and a bottom surface and at least one terminal disposed within the body. The connector has at least one chamber configured to accept a wire adjacent at least one terminal, wherein the chamber can be viewed through the bottom surface of the connector that is transparent and a non-transparent feature positioned proximate the top surface, wherein the feature prevents viewing of the chamber.

### FIELD OF THE INVENTION

Ethernet connectors for data cable terminations and connections.

### BACKGROUND

Communication cables and in particular data cables used for the transmission of information according to the Ethernet standard are commonplace and used in a multitude of environments including commercial offices and buildings, industrial environments, and with increasing frequency, residences. The data cables most commonly used are generally referred to as twisted wire pairs. A typical data cable contains two connectors on both ends to connect a computer to another computer or network device.

The typical connector may be for applications such as ethernet, which uses data cables having twisted pairs of wires within to minimize interference or cross-talk between the individual wires in the cable, which may be required to travel relatively long distances. To prevent unwanted interference in the wires, the length of untwisted wires before entering the connector were kept to a minimum, typically only 0-2 inches long. The short untwisted wire lengths were then typically inserted into connectors having an insulation displacement contact (IDC) that commonly requires special tools to compress. Furthermore, the very short wire segments often made the risk high of switching the wire order unintentionally, thus leading to the creation of defective connectors. Additionally, the short wire segments and the typical style IDC made the chance of bad connections a common problem. These deficiencies required testing of all cables a requirement to avoid problems associated with the old style common connector. The instant invention addresses the aforementioned deficiencies with a new novel connector system.

### SUMMARY OF THE INVENTION

A first aspect of the present invention provides a visual check connector comprising: a body having a top surface, and a bottom surface; at least one terminal disposed within said body; at least one chamber configured to accept a wire adjacent said at least one terminal, wherein said at least one chamber can be viewed through the bottom surface of the connector, said bottom surface being transparent; and a non-transparent feature, said feature positioned proximate said top surface, wherein said feature prevents viewing of said at least one chamber.

A second aspect of the present invention provides a visual check ethernet connector comprising: a transparent body having a top surface, and a bottom surface; at least eight terminals disposed within said transparent body; at least eight chambers configured to accept a wire adjacent said at least one terminal, wherein said at least one chamber can be viewed through said bottom surface of the connector; a non-transparent feature, said feature positioned proximate said top feature, wherein said surface prevents viewing of said at least one chamber; and a locking tab, said locking tab is positioned on said top surface of said connector.

A third aspect of the present invention provides a method of preventing wire ordering errors in a connector comprising: providing a connector having a body with a transparent side and a non-transparent side and at least two wire receiving chambers having an insulation displacement contact therein; providing a cable with a plurality of different colored wires; providing a wiring order that corresponds to an orientation of the plurality of different colored wires viewed though the transparent side of said connector; inserting the wires into said at least two wire receiving chambers creating an actual wire ordering; and comparing said actual wire ordering with said wire ordering, said comparison including viewing said inserted wires through said transparent side.

A fourth aspect of the present invention provides a visual check ethernet connector comprising: a transparent body having a top surface, and a bottom surface; at least eight terminals disposed within said transparent body; at least eight chambers configured to accept a wire adjacent said at least one terminal, wherein said at least one chamber can be viewed through said bottom surface of the connector; a means of preventing viewing of said chambers through said top surface.

### BRIEF DESCRIPTION OF THE DRAWINGS

Some embodiments of this invention will be described in detail, with reference to the following figures, wherein like designations denote like members, wherein:

FIG. 1 shows a view of an embodiment of the cable connector;

FIG. 2 shows a view of an embodiment of the cable connector showing wires inserted into the connector;

FIG. 3 shows a wiring socket for the cable connector;

FIG. 4 shows a wiring order of an embodiment of the cable connector;

FIG. 5 shows a wiring order of an embodiment of the cable connector;

FIG. 6 shows a wiring order of an embodiment of the cable connector; and

FIG. 7 shows a wiring order of an embodiment of the cable connector.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

A first aspect of the present invention provides a visual check connector 100 to address the problems associated with the wiring order of a connector having at least two or more wires by preventing errors with the novel connector. Connectors are only useful if wired in the correct order and connectors wired improperly are considered defective and may cause lengthy delay in pinpointing system inoperablity during initial setup. The installer may make dozens of cables of different lengths at the job site when installing equipment requiring data transfer therebetween.

In a past attempt to correct the problem with wiring incorrectly a connector having a transparent body has been provided to the installer to facilitate a check of the order of wiring. However completely transparent bodies are not sufficient to prevent all wiring errors and also create other problems. For example, an error that may occur with a transparent connector is the inserting and viewing of the wires with the connector upside down thereby resulting in an inverted wiring order. Furthermore, hurried inspection of the transparent connector may visually indicate a correct order and not immediately reveal an inverted wiring problem.

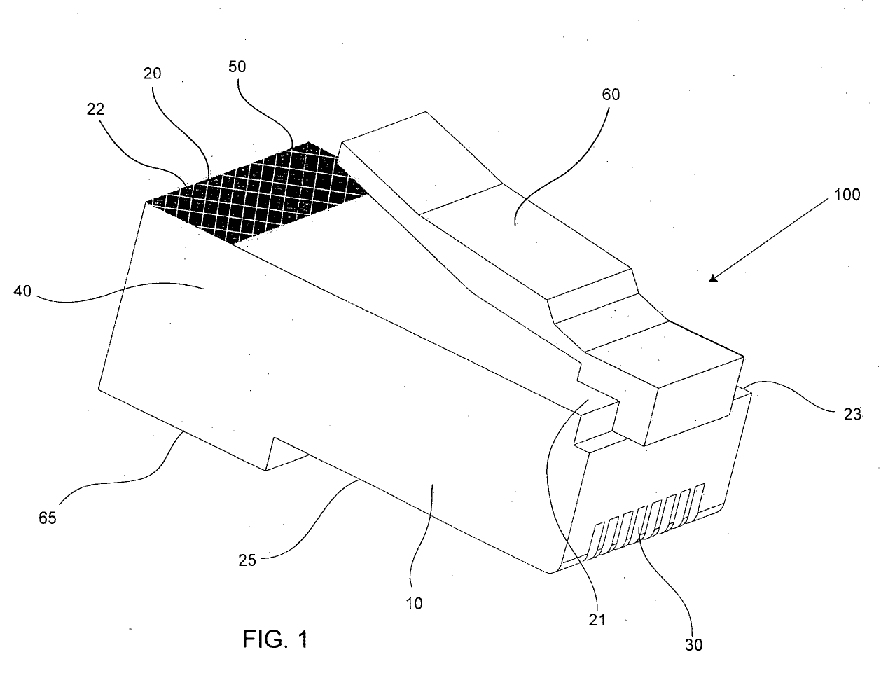

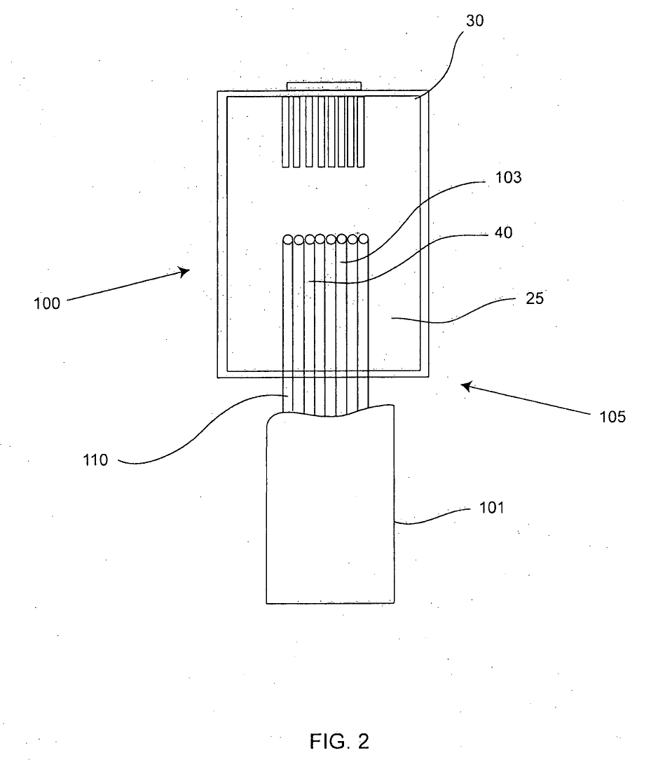

As shown in FIGS. 1 and 2, the visual check connector 100 retains all the benefits of a transparent body without the problems associated with inversion errors by providing a body 10 having a top surface 20, and a bottom surface 25 and at least one terminal 30 disposed within the body 10. The body 10 has at least one chamber 40 configured to accept a wire 101 adjacent the terminal 30. The chamber 40 can be viewed through the bottom surface 25 of the connector 100, said bottom surface 25 being transparent. Common wiring errors may be prevented by providing a non-transparent feature 50, said feature 50 positioned proximate said top surface 20, wherein said feature 50 prevents viewing of the wire 101 in the chamber 40.

The body 10 may be formed of a non-conducting material that may let visible light pass through at least the bottom surface 25. The bottom surface 25 may be clear or may include a clear or transparent portion. The body 10 may be formed of a rigid material such as an acrylic or polycarbonate resin that may be injection molded in a single step to form a single piece or in multiple steps with the body 10 being assembled from multiple components. When the connector is any of the Registered Jack types, such as an RJ-45 type ethernet connector, a locking tab 60 may be attached or molded directly into the body 10. The locking tab 60 may be positioned on said top surface 20 of said connector 100. The RJ-45 type ethernet connector may have at least eight terminals disposed within said body 10, which may be inserted separately or molded directly into the connector 100 as an insert. The connector 100 may optionally have a cable strain relief section 65.

A standard clear or transparent connector may be converted to the novel connector 100 with addition of a sticker 21. The sticker 21 may be applied to said top surface 20 of the body 10 to prevent viewing of the chamber 40 from the top surface 20. The sticker 21 may indicate that the connector is being viewed from said top surface 20.

Furthermore, a standard clear connector may be converted to the novel connector 100 with addition of a light diffusing surface structure 22. The light diffusing surface structure 22 may be applied to the top surface 20 of the body 10 to prevent the chamber 40 from being viewed from the top surface 20. The light diffusing surface structure 22 may be added during or after the injection molding process. The surface of the mold of the injection molding machine that corresponds to the top surface 20 of the connector 100 may be abraded or pitted to produced an uneven surface sufficient to diffuse light reflected from within the connector to prevent viewing of the wire 101 within the chamber 40. The light diffusing surface structure 22 may be a plurality of irregular shapes formed into said top surface to scatter light preventing viewing of said chamber.

The light diffusing surface structure 22 may be added after injection molding or to modify an existing connector by surface treatment. The surface treatment may be created by abrasion caused by sand blasting, sand paper or any abrasive media, which would create surface scratching, or by other cutting elements that may deform the top surface 20 and thus facilitate diffusion of the light preventing viewing of the interior of the surface from that side. Depending on the type of polymer used in the connector a chemical or solvent may be applied to the surface to create surface hazing and cracking by attacking the surface layer of polymer which would cause reduced clarity on that side.

Furthermore, the light diffusing surface structure 22 may be created by secondary processing by contacting the top surface 20 with a heated structure. The heated structure could leave small surface indents thereby causing light diffusion. The heated structure could contact a small portion of the top surface 20 or the whole surface 20 simultaneously. The heated structure may be a structure that includes a heater element to raise the temperature of the surface above the polymer melting temperature, which when in contact with the surface 20 of the connector 100 would cause localized melting and displacement of surface material that corresponds to an irregular surface structure that would diffuse light.

Furthermore, a knurled surface feature 22 may be formed in at least a portion of top surface 20, said knurled surface feature 22 preventing at least a portion of the chamber 40 from being viewed from an angle looking through the top surface 20. As discussed above, the knurled surface feature 22 may be formed during the injection molding of the connector or be added to a standard connector. When formed during injection molding, the mold surface that corresponds to the top surface 20 has the reverse of the knurled surface feature 22 formed therein so as to create the knurled surface feature 22 when injection molded. Another manner to create the knurled surface feature 22 may be by modifying a standard connector having a clear body 10 by either machining the top surface 20 or by applying a heated structure that included a heater element to raise the temperature of the surface above the polymer melting temperature, which when in contact with the surface 20 of the connector 100 would cause localized melting and displacement of surface material that corresponds to the formation of the knurled surface feature 22.

A still further manner of configuring an embodiment of a connector 100 is with a paint coating 23 disposed upon said top surface 20, said paint coating 23 preventing the chamber 40 from being viewed from said top surface 20. The connector 100 may be initially formed as a clear connector, which then may have a paint coating 23 placed on the top surface. The paint coating 23 may be any color such as white, red, blue or any other shade within the visible light spectrum that would prevent viewing through the top surface 20 and alert the installer to flip the connector body 10 over for proper orientation of the connector 100.

Even further still, embodiments of the connector 100 may include a colored, non-transparent insert 24, said insert 24 integrated or snapped onto said top surface 20, said non-transparent insert 24 preventing said chamber 40 from being viewed from said top surface 20. The non-transparent insert 24 could be placed into an injection molding cavity and incorporated in the body 10 during the production of the connector 100. The non-transparent insert 24 may be a shell or overlay that is snapped over the top surface 20, which may or may not include covering the sides. The non-transparent insert 24 or overlay may be held on by glue or by mechanical interlock such as a male or female receptor or wings that may expand and grasp the sides of the connector 100 like a clip.

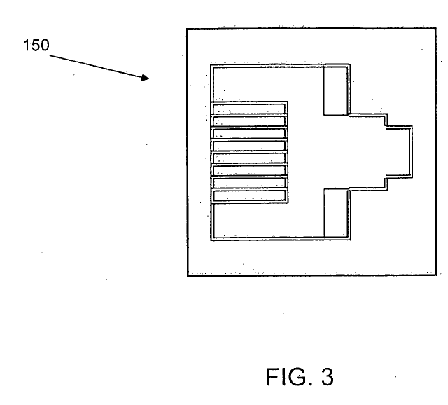

An embodiment of a visual check connector 100, as shown in FIGS. 1 and 2, may comprise a transparent body 10 having a top surface 20, and a bottom surface 25. An ethernet type embodiment of the connector 100 may have at least eight terminals 30 disposed within said transparent body 10. Moreover, there may be at least eight chambers 40 configured to accept a wire 101 adjacent said at least one terminal 30, wherein said at least one chamber 40 can be viewed through said bottom surface 25 of the connector 100. Embodiments of the connector 100 may be configured to mate with a standard Registered Jack-type socket 150 as depicted in FIG. 3.

A visual check ethernet connector 100 may include a non-transparent feature 50, said feature positioned proximate said top surface 20, wherein said feature 50 prevents viewing of said at least one chamber 40. The non-transparent feature 50 may be any feature that would prevent viewing of the chamber 40 of the connector 100 such as logos, trademarks, pictures or printing including instructions. A locking tab 60 may be positioned on the top surface 20 of the connector 100. A visual check ethernet connector 100 may include a cable strain relief section 65 that may help prevent failure of the connector 100.

The non-transparent feature 50 may include a sticker 21, said sticker 21 applied to said top surface 20 of said transparent body 10, wherein said sticker 21 indicates that the connector is being viewed through said top surface 20. The sticker could include a wiring diagram of the correct order of the wiring for that type of connector 100 being produced and could be applied by the installer to the connector 100 just prior to production of the connector from the cable.

The non-transparent feature 50 may include a light diffusing surface structure 22, wherein said light diffusing surface structure 22 is applied to said top surface 20 of said transparent body 10 to prevent said chamber 40 from being viewed through said top surface 20.

The non-transparent feature 50 may include a knurled surface feature 22 as shown in FIG. 1 formed in a portion of the top surface 20. The knurled surface feature 22 may be used for both preventing said chamber 40 from being viewed through said top surface 20 and assisting with gripping of the connector during insertion into socket 150. The knurled surface feature 22 may be formed during the molding of the connector 100 or be a feature added to the surface as a secondary operation either by machining or with a heated surface and may cover a portion or all of the top surface 20.

The non-transparent feature 50 may include a paint coating 23 disposed upon said top surface 20, said paint coating 23 preventing the chamber 40 from being viewed through said top surface 20. The paint coating 23 may be any pigmenting or staining fluid that is applied to the top surface 20 in a sufficient concentration to obstruct viewing of the chamber 40. The paint could be a stain (solvent with pigment) where the solvent allows the pigment to migrate into the surface 20 or an oil or latex based system that forms a cured outer layer.

The non-transparent feature 50 may include a colored, non-transparent overlay 24, said overlay 24 integrated into or attached to the top surface 20, said non-transparent overlay 24 preventing said chamber 40 from being viewed through said top surface 20. The overlay 24 may be a cover that snaps over and blocks the top surface 20. The overlay 24 may also be a surface that is glued or otherwise affixed over the top surface 20.

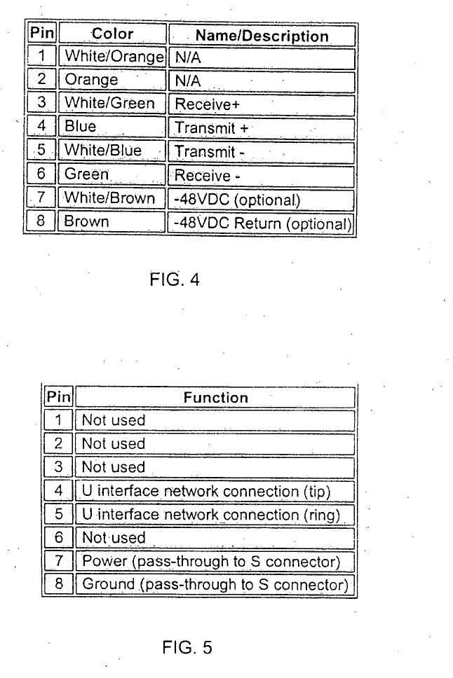

Referring further to FIGS. 1-3 and with additional reference to FIGS. 4-7, a method of preventing wire ordering errors in connector 100 may comprise the step of providing a connector 100 having a body 10 with a transparent side 25 and a non-transparent side 20 and at least two wire receiving chambers 40 having an insulation displacement contact 30 therein. The non-transparency of the side 20 may be accomplished with any of the above mentioned manners.

An additional method step may include providing a cable 101 with a plurality of different colored wires 110. Moreover a wiring order 102 may be provided, some possible examples shown in FIGS. 4-7, wherein the wiring order corresponds to an orientation of the plurality of different colored wires 103 viewed though the transparent side 25 of said connector 100.

Further methodology may include the connector being prepared by inserting the wires 103 into at least two wire receiving chambers 40 creating an actual wire ordering 105. To ensure a working connecter, an additional step may be comparing the actual wire ordering 105 with said wire ordering 102, said comparison including viewing said inserted wires 103 through said transparent side 25. Once it is verified that the actual order 105 is correct then another method step may include securing the wires 103 into said insulation displacement contact 30 making a connector cable 115.

As shown in FIGS. 4-7, a variety of pinouts or wire ordering 102 for Ethernet may be possible and an RJ-45-type connector may be used for a variety of purposes. For example, the connector may be commonly used for 10Base-T and 100Base-TX Ethernet connections. However, only two pairs of wires in the eight-pin RJ-45 connector may be used to carry Ethernet signals, and both 10BASE-T and 100BASE-TX may use the same pins. Still further, a crossover cable made for one RJ-45-type connector may also work with other types.

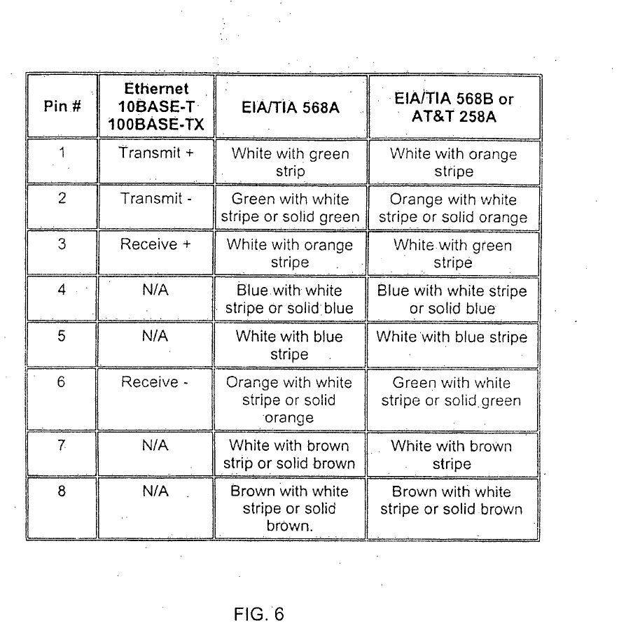

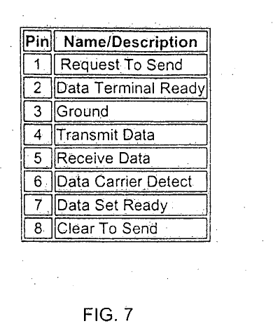

FIG. 4 shows a chart having a wiring order for an RJ-45 connector used on certain ISDN S/T interfaces. FIG. 5 shows a chart for an ISDN BRI U port wiring order for a Cisco 750 series router. The pinouts or wire order 102 may be custom color coded by the installer. FIG. 6 shows a comparison of three different wire orders 102 that an installer may select for the installation. FIG. 7 shows an RJ-45 pinout or wire order 102 that may be used for a RocketPort serial interface card.

In addition an embodiment of a visual check ethernet connector 100 may comprise a transparent body 10 having a top surface 20, and a bottom surface 25. Moreover, there may be at least eight terminals 30 disposed within said transparent body 10, which is typical of an RJ-45 type connector. There may also be at least eight chambers 40 configured to accept a wire 101 adjacent said at least one terminal 30, wherein said at least one chamber 40 can be viewed through said bottom surface 25 of the connector 100.

A visual check ethernet connector 100 may also have a means of preventing viewing of said chambers 40 through said top surface 20. The means of preventing viewing said chambers 40 may include a sticker, a light diffusing surface structure, a knurled surface feature, a paint coating, a non-transparent mold insert or any other known implement operable to obstruct viewing of the chambers 40 discussed herein.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A visual check connector comprising:
a body having a top surface, and a bottom surface;
at least one terminal disposed within said body;
at least one chamber configured to accept a wire adjacent said at least one terminal, wherein said at least one chamber can be viewed through the bottom surface of the connector, said bottom surface being transparent; and
a non-transparent feature, said feature positioned only upon said top surface, wherein said feature prevents viewing of said at least one chamber through the top surface.

2. The visual check connector of claim 1 further comprising:
a locking tab, said locking tab positioned on said top surface of said connector.

3. The visual check connector of claim 1 further comprising:
a sticker, said sticker applied to said top surface of said body, wherein said sticker indicates that the connector is being viewed from said top surface.

4. The visual check connector of claim 1 further comprising:
at least eight terminals disposed within said body.

5. The visual check connector of claim 1 further comprising:
a light diffusing surface structure, wherein said light diffusing surface structure is applied to said top surface of said body to prevent said chamber from being viewed from said top surface.

6. The visual check connector of claim 5 wherein said light diffusing surface structure is a plurality of irregular shapes formed into said top surface to scatter light preventing viewing of said chamber.

7. The visual check connector of claim 1 further comprising:
a cable strain relief section

8. The visual check connector of claim 1 further comprising:
a knurled surface feature formed in said top surface, said knurled surface feature preventing said chamber from being viewed from said top surface.

9. The visual check connector of claim 1 further comprising:
a paint coating disposed upon said top surface, said paint coating preventing said chamber from being viewed from said top surface.

10. The visual check connector of claim 1 further comprising:
a colored, non-transparent insert, said insert integrated into said top surface, said non-transparent insert preventing said chamber from being viewed from said top surface.

11. A visual check ethernet connector comprising:
a transparent body having a top surface, and a bottom surface;
at least eight terminals disposed within said transparent body;
at least eight chambers configured to accept a wire adjacent said at least one terminal, wherein said at least one chamber can be viewed through said bottom surface of the connector;
a non-transparent feature, said feature positioned only upon said top surface, wherein said feature prevents viewing of said at least one chamber through the top surface; and
a locking tab, said locking tab is positioned on said top surface of said connector.

12. The visual check connector of claim 11 further comprising:
a sticker, said sticker applied to said top surface of said transparent body, wherein said sticker indicates that the connector is being viewed through said top surface.

13. The visual check connector of claim 11 further comprising:
a light diffusing surface structure, wherein said light diffusing surface structure is applied to said top surface of said transparent body to prevent said chamber from being viewed through said top surface.

14. The visual check connector of claim 11 further comprising:
a cable strain relief section

15. The visual check connector of claim 11 further comprising:
a knurled surface feature formed in said top surface, said knurled surface feature preventing said chamber from being viewed through said top surface.

16. The visual check connector of claim 11 further comprising:
a paint coating disposed upon said top surface, said paint coating preventing said chamber from being viewed through said top surface.

17. The visual check connector of claim 11 further comprising:
a colored, non-transparent overlay, said overlay integrated into said top surface, said non-transparent overlay preventing said chamber from being viewed through said top surface.

18. A method of preventing wire ordering errors in a connector comprising:
providing a connector having a body with a transparent side and a non-transparent side and at least two wire receiving chambers having an insulation displacement contact therein;
providing a cable with a plurality of different colored wires;
providing a wiring order that corresponds to an orientation of the plurality of different colored wires viewed though the transparent side of said connector;
inserting the wires into said at least two wire receiving chambers creating an actual wire ordering; and
comparing said actual wire ordering with said wire ordering, said comparison including viewing said inserted wires through said transparent side.

19. The method of preventing wire ordering errors in a connector of claim 18 further comprising:
securing the wires into said insulation displacement contact making a connector cable.

20. A visual check ethernet connector comprising:
a transparent body having a top surface, and a bottom surface;
at least eight terminals disposed within said transparent body;
at least eight chambers configured to accept a wire adjacent said at least one terminal, wherein said at least one chamber can be viewed through said bottom surface of the connector;
a means of preventing viewing of said chambers through said top surface.
